(19) United States
(12) Patent Application Publication
(10) Pub. No.: US 2002/0027508 A1
(43) Pub. Date: Mar. 7, 2002

(54) Power failure managing device and method for managing a power failure

(76) Inventor: Tsutomu Baba, Suwa-gun (JP)

Correspondence Address: Eugene LeDonne, Esq., Reed Smith LLP, 17th Floor, 375 Park Ave, New York, NY, 10152, US

(21) Appl. No.: 09/933,856

(22) Filed: Aug. 20, 2001

(30) Foreign Application Priority Data
Aug. 21, 2000 (JP) 2000-250308

(51) Int. Cl. G08B 23/00

(52) U.S. Cl. 340/693.2; 340/693.1

(57) ABSTRACT

The present invention provides for a power failure managing device in a system including a backup power source; a CPU having a processing unit that detects a power failure and actuates the backup power source upon detecting the power failure; and a rewritable memory that records the status of the system at the moment of the power failure; wherein if the CPU determines that the backup power source is not properly functioning at the moment of the power failure, information from the backup power source is recorded in the memory.

### RELATED APPLICATIONS

This application claims Paris Convention priority of Japanese Patent Application Number 2000-250308 filed on Aug. 21, 2000, the complete disclosure of which is hereby incorporated by reference.

### BACKGROUND OF THE INVENTION

1. Field of the Invention

The present invention relates to a power failure managing device and a method for managing a power failure. More specifically, the present invention relates to a power failure managing device that records information which will be used to recover the process that underwent the power failure.

2. Related Art

A conventional system having a central processing unit (“CPU”), a memory device, etc. for data processing is normally equipped with a backup power source. When a power failure occurs, the CPU detects the power failure and immediately actuates the backup power source so that the power failure management is performed depending on the process the system was performing at the moment of the power failure to facilitate process recovery after the power failure.

In some card reading/writing systems (hereinafter denoted as a “card reader”), when a power failure occurs, a CPU detects the power failure and immediately actuates the backup power source so that power failure management is performed depending on the process the system was performing at the moment of the power failure. For example, when the power went off during the writing of data on a card, rewriting is completed and the card is discharged. Or, if there is no attempt of removing the card, the card is taken into the card reader again for the purpose of security. After managing the power failure as described above, information on the status of the card reader at the moment of the power failure, such as “the card does or does not exit inside the device”, “an error has occurred during the card transportation”, etc., is recorded in a flash memory. As such, when the power source comes back on, an appropriate recovery process is performed based on the information recorded in the flash memory.

However, even when the backup power is not sufficiently or not at all provided because the backup power source is not properly connected or functioning, a system such as a card reader attempts to execute power failure management as the power goes off. At that time, power failure management cannot be completed in the short period of time from the detection of the power failure to the actual turn-off of the CPU. The card reader comes to a halt under the condition that the power failure management is incomplete. Therefore, the status of the card reader at the moment of the power failure cannot be recorded in the flash memory and accordingly, the process which underwent the power failure cannot be recovered when the power comes back on.

Even when the card reader is not performing any process at the moment of a power failure and the information concerning the status of the card reader is immediately input in the process of recording in the flash memory, the data in the entire block needs to be temporarily erased to record the change of the bit data “0” to “1” due to the characteristic of the flash memory. For this reason, information on the status of the card reader at the moment of a power failure cannot be recorded in the flash memory in the short period of time from the detection of the power failure to the actual turn-off of the CPU. In the worst case, if the CPU stops working while other data in the flash memory is being erased, the card reader itself will not properly function when the power comes back on.

Accordingly, it is one of the purposes of the present invention to provide a power failure managing device and method of using the same in which even if the backup power source is not properly functioning, essential minimum information concerning the status of a system at the moment of the power failure can be provided to recover the process when the power comes back on.

### SUMMARY OF THE INVENTION

It has now been discovered that this purpose, among others, can be achieved by the present invention which provides for a power failure managing device in a system. The power failure managing device includes a backup power source, a CPU having a processing unit that detects a power failure and actuates the backup power source upon detecting the power failure and a rewritable memory that records the status of the system at the moment of the power failure. If the CPU determines that the backup power source is not properly functioning at the moment of the power failure, information from the backup power source is recorded in the memory. Therefore, even if the backup power source is not properly functioning, essential minimum information concerning the status of the system at the moment of the power failure is recorded in the memory and can be provided when the power comes back on. As such, the steps that should be taken to recover the process the system was performing are known. Also, if the backup power source is not properly functioning, power failure management is not performed so that the system does not stop with an incomplete power failure management and will normally start when the power comes back on.

Preferably, information from the backup power source is simply recorded in the memory by overwriting. Thus, information can be quickly recorded in the memory as there is no need to erase data in the memory. In addition, even if the backup power source cannot be used, it is possible to quickly record information from the backup power source in the short period of time from the detection of a power failure to the actual turn-off of the CPU.

Further, the memory preferably includes a flash memory in which the change of bit data from “1” to “0” can be immediately accomplished by overwriting. Considering this advantage of a flash memory, even if a backup power source cannot be used, information from the backup power source can be quickly recorded in a flash memory in the short period of time from the detection of a power failure to the actual turn-off of the CPU.

Information from the backup power source preferably includes the charge status of the backup power source, the connection status of the backup power source to the system or both. As such, the steps that should be taken to recover the process are known and the problem with the connection or the electrical charge of the backup power source can be corrected.

The present invention also provides for a power failure managing device in a card reader. The power failure managing device includes a backup power source, a CPU having a processing unit that detects a power failure and actuates the backup power source upon detecting the power failure and a rewritable memory that records the status of a card reader at the moment of the power failure. If the CPU determines that the backup power source is not properly functioning at the moment of the power failure, information from the backup power source is recorded in the memory. Therefore, even when the backup power source has a problem, essential minimum information concerning the status of the card reader at the moment of the power failure is recorded in the memory and can be provided to recover the process the system was performing when power comes back on. In this manner, the steps that should be taken to recover the process after the power failure are known. Also, when the backup power source has a problem, power failure management is not performed so that the card reader does not stop with an incomplete power failure management and will properly start when the power is turned back on.

The present invention is also directed to a method for managing a power failure including the use of a power failure managing device as described above. In particular, the method includes the steps of (a) executing a process monitoring task to detect a power failure, (b) determining whether the backup power source is properly functioning and (c) depending upon whether the power source is properly functioning, either actuating the backup power source to perform normal power failure management or recording information from the backup power source in the memory, wherein the information is used to recover the process the system was performing prior to the power failure.

### BRIEF DESCRIPTION OF THE DRAWINGS

FIG. 1 is a block diagram of a power failure managing device of the present invention.

FIGS. 2(A)-(C) show the overwriting characteristic of a rewritable memory used in the present invention. In particular, FIG. 2(A) shows the data before overwriting, FIG. 2(B) shows the data that needs to be written and FIG. 2(C) shows the data after overwriting.

FIG. 3 is a flowchart showing the steps followed by a power failure managing device of the present invention.

FIGS. 4(A)-(D) show information from the backup power source being recorded in a rewritable memory. In particular, FIG. 4(A) shows the initial data and FIGS. 4 (B)-(D) show the data that contain information to overwrite the data shown in FIG. 4(A).

### DETAILED DESCRIPTION OF THE INVENTION

An embodiment of the present invention is described hereinafter based on the drawings.

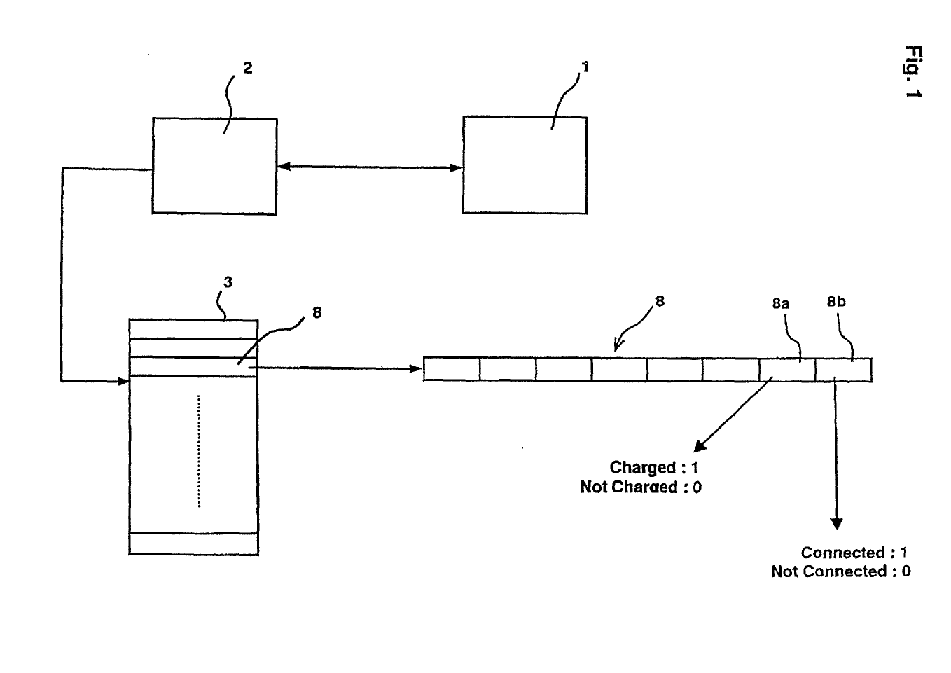

FIGS. 1 through 4(D) illustrate an embodiment of a power failure managing device of a card reader of the present invention. A power failure managing device 9 includes a backup power source 1, a CPU 2 having a process unit that detects a power failure and actuates the backup power source 1 upon detecting a power failure and a rewritable memory 3 that records the status of a system at the moment of a power failure. When the CPU 2 determines that the backup power source 1 is not properly functioning at the moment of a power failure, information from the backup power source 1 is recorded in the memory 3.

In particular, the CPU 2 executes a process monitoring task 4 that detects a power failure and actuates the backup power source 1 upon detecting a power failure. Also, the CPU 2 constantly monitors the status of the backup power source 1 during the process monitoring task 4. For example, the CPU 2 detects signals sent by a backup power source 1 and depending on the signals, it determines whether or not the backup power source 1 is connected to the system, whether or not the backup power source 1 is charged, whether or not other functions of the backup power source 1 are effectively functioning, etc.

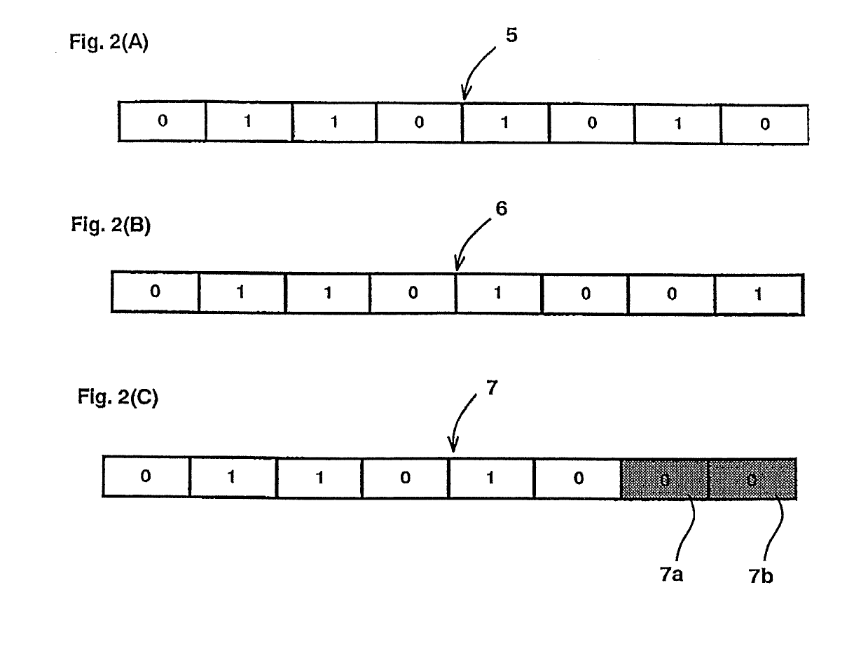

The memory 3 is a rewritable, nonvolatile memory and in this embodiment, it is a flash memory. The flash memory 3, in which binary data composed of “1” and “0” is recorded, has the following characteristics. First, rewriting “1” with “0” can be accomplished by overwriting, however, rewriting “0” with “1” is accomplished by first temporarily moving the data of one block (one byte consisting of 8 bits) aside to erase all the bits in the block and then rewriting the new data while writing back the moved data. For example, as illustrated in FIG. 2(A), when the data 5 of one byte is overwritten with the data 6, the data becomes the data 7. In other words, although the bit 7a reflects the change from “1” to “0”, the bit 7b does not reflect the change from “0” to “1”.

Although a unit for a block differs depending on the product, changing bit data from “0” to “1” cannot be accomplished by merely overwriting no matter how long the unit is, but requires erasing all of the data in the entire block as a unit. Compared to changing the bit from “1” to “0”, more time is needed to change the bit from “0” to “1”.

On the other hand, changing the bit data from “1” to “0” can be accomplished simply by overwriting. Therefore, even if the backup power source 1 cannot be used, it is possible to quickly record information on the backup power source 1 in the short period of time from the detection of a power failure to the actual turn-off of the CPU 2, depending on the composition of the bit data that expresses the information.

For example, essential minimum information from the backup power source 1 that needs to be recorded in the flash memory 3 (hereinafter denoted as “the backup power source information”) is obtained in the following manner.

In this embodiment, the backup power source information is set as “charged”/“not charged” and “connected”/“not connected”. One byte in the flash memory 3 may be assigned as a region 8 (hereinafter the region 8 being denoted as “the power source information region 8”) for storing the backup power source information. The backup power source information is recorded in two predetermined bits in the region 8. For example, if the last two bits are used, the last bit is a connection confirming bit 8b and the second bit from the last is a charge confirming bit 8a. In other words, when the charge confirming bit 8a is “1”, the backup power source 1 is “charged” and when the charge confirming bit 8a is “0”, the backup power source 1 is “not charged”. In the same manner, when the connection confirming bit 8b is “1”, the backup power source 1 is “connected” and when the connection confirming bit 8b is “0”, the back-up power source 1 is “not connected”. In the initial data of the power source information region 8, all of the bits are “1”. The address of the power source information region 8 in the flash memory 3 is programmed to read into a registry in the CPU 2 when the system starts so that the CPU 2 can access the power source information region 8 when the power turns off.

According to the power failure managing device 9 configured as described above, even when the backup power source 1 is not properly functioning, essential minimum information concerning the status of the system at the moment of a power failure can be provided in the following manner when power comes back on.

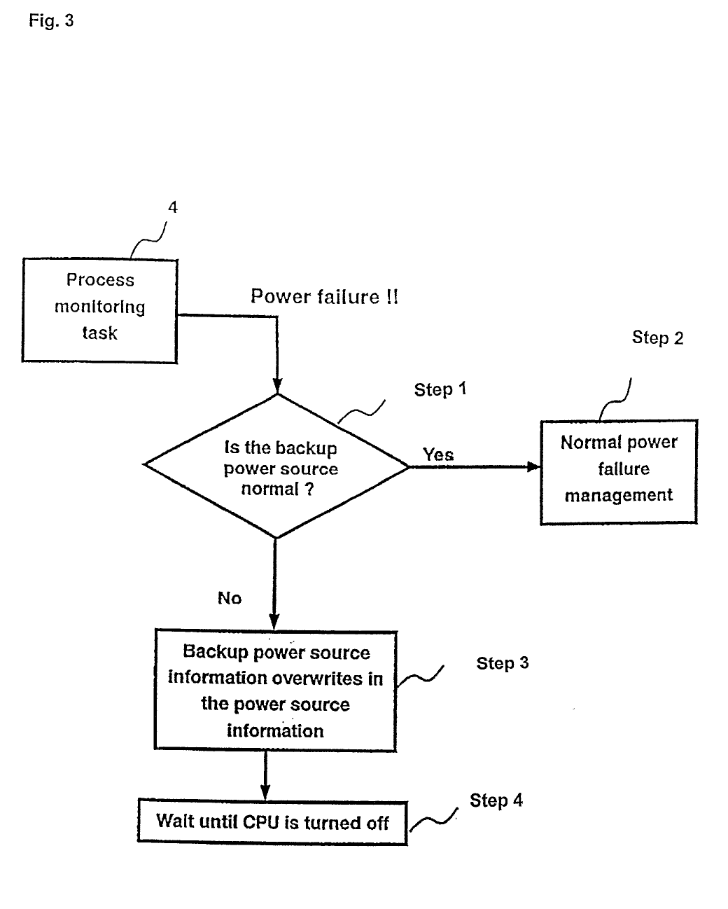

In particular, as a power failure is detected by a process monitoring task 4 in the CPU 2, the CPU 2 determines if the backup power source 1 is properly functioning (See FIG. 3, Step 1). The CPU 2 constantly monitors via the process monitoring task 4 the status of the backup power source 1 including whether or not the backup power source 1 is connected, whether or not it is charged, etc., for a quick determination. Therefore, if the backup power source 1 is properly ready (See FIG. 3, Step 1 to Step 2), it is immediately actuated so that a predetermined, normal power failure management is performed (See FIG. 3, Step 2) according to the process that underwent the power failure.

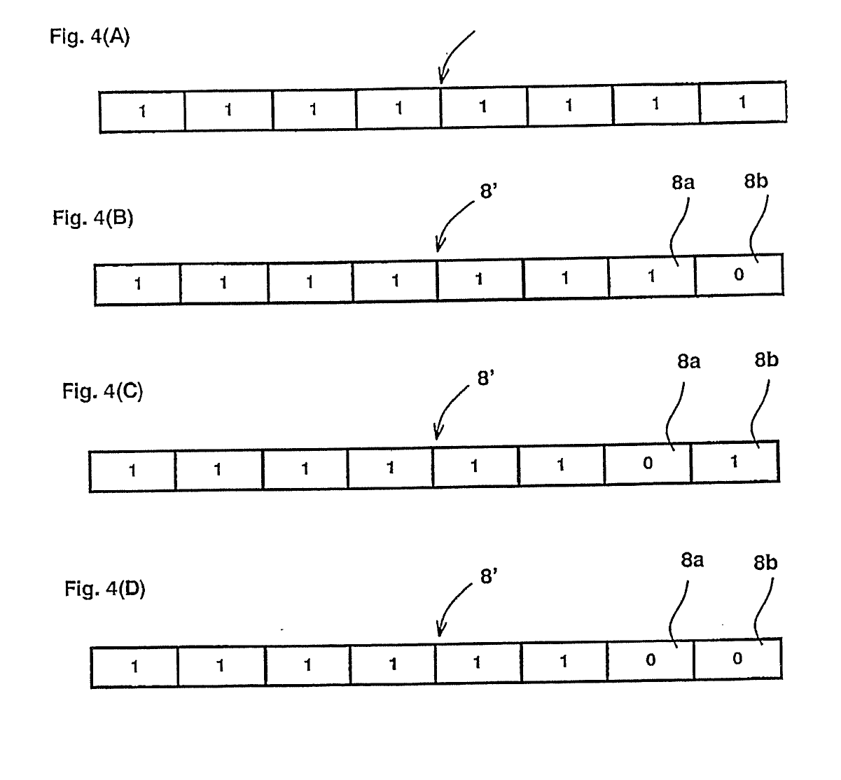

On the other hand, if the backup power source 1 has a problem, for example, if it is not connected or not charged (See FIG. 3, Step 1 to Step 3), the backup power source information that presents the status of the backup power source 1 overwrites the power source information region 8 (See FIG. 3, Step 3). If the power failure occurs when the backup power source 1 is not properly connected, the backup power source information 8′ having “0” for the connection confirming bit 8b overwrites the initial data as illustrated in FIG. 2(B). If the power failure occurs when the backup power source 1 is not charged, the backup power source information 8′ having “0” for the charge confirming bit 8a overwrites the initial data as illustrated in FIG. 4(C). If the power failure occurs when the backup power source 1 is neither properly connected nor charged, the backup power information 8′ having “0” for both connection confirming bit 8b and charge confirming bit 8a overwrites the initial data.

In the initial data of the power source information region 8, all bits are “1” (See FIG. 4(A)). Therefore, to change “1” to “0”, the backup power source information 8′ simply overwrites. Consequently, even when the backup power source 1 cannot be used, the backup power source information can be quickly recorded in the short period of time from the detection of a power failure to the actual turn-off of the CPU 2. It should be noted that if the power failure occurs when the backup power source 1 is not charged and then the power comes back on, the power source information region 8 is changed as illustrated in FIG. 4(C) in which the charge confirming bit 8a is “0. Suppose that another power failure occurs in succession. Then, if another power failure occurs when the backup power source 1 is not properly connected, the power source information region 8 is changed as illustrated in FIG. 4 (D) in which the connection confirming bit 8b is “0”. At that time, the data, “not charged”, recorded at the previous power failure cannot be changed back to the initial data, and therefore the problem at the second power failure cannot be specified between “not charged” and “not connected”. However, it can be at least assumed that normal power failure management could not be performed because the backup power source had a problem.

After the backup power source information is written in the power source information region 8, the CPU 2 does nothing until it is turned off (See FIG. 3, Step 4).

As such, even if the backup power source 1 has a problem, essential minimum information concerning the status of the system at the moment of a power failure can be obtained from the backup power source information, which is written in the power source information region 8, when the power comes back on. The steps that should be taken to recover the process are then known. If the backup power source 1 has a problem, power failure management is not performed (See FIG. 3, Step 1 to Step 3) and therefore, a card reader is prevented from halting due to an incomplete power failure management. Thus, the card reader will normally start when the power comes back on.

It should be noted that the connection or the charge problem of the backup power source 1, which is indicated in the backup power source information, can be corrected in the managing process when the power comes back on. Consequently, when a power failure occurs the next time, normal power failure management is performed (See FIG. 3, Step 1 to Step 2), in which all of the bits in the power source information region 8 are rewritten with “1” to return to the initial status. At that time, since the backup power source 1 is properly functioning, sufficient time can be provided even for rewriting “0” to “1”.

It should also be noted that essential minimum information that should be recorded in the flash memory 3 is not limited to that described in the above embodiment, but may contain other information as well. As long as the information to be recorded can be written within 8 bits in the power source information region 8, the time required for processing is the same as that in the above embodiment. Each bit in the power source information region 8 may be assigned to write an item to be verified when power comes back on after a power failure. In this case, eight items can be listed. For example, the information, such as whether or not the various functions of the backup power source 1 are valid, or the life expectancy or the current charge level of the backup power source 1, may be provided.

It is preferred that the size of the power source information region 8 be as small as it can so that essential minimum information can be obtained in a short period of time. However, it is not necessarily limited to one byte. Depending on the processing ability of the CPU 2, two bits or more may be used for the power source information region 8.

Also, the memory 3 is not limited to a flash memory. Another type of rewritable memory 3 that has the overwriting characteristic as mentioned above may be used. For example, an EEPROM (Electrically Erasable Programmable Read Only Memory), which is rewritable and nonvolatile, may be used.

Although in the above mentioned embodiment the power failure managing device of the present invention is applied in a card reader as a preferred example, it is not limited to this. The power failure managing device of the present invention can be used in a system that has memory devices, such as a CPU and a flash memory as an information processing ability.

Thus, while there have been described what are presently believed to be the preferred embodiments of the present invention, those skilled in the art will realize that other and further embodiments can be made without departing from the spirit and scope of the invention, and it is intended to include all such further modifications and changes as come within the true scope of the invention.

What is claimed is:

1. A power failure managing device in a system, comprising:
a backup power source;
a CPU having a processing unit that detects a power failure and actuates said backup power source upon detecting said power failure; and
a rewritable memory that records the status of said system at the moment of said power failure;
wherein if said CPU determines that said backup power source is not properly functioning at the moment of said power failure, information from said backup power source is recorded in said memory.

2. The power failure managing device according to claim 1, wherein said information from said backup power source is recorded in said memory by overwriting.

3. The power failure managing device according to claim 1, wherein said memory comprises a flash memory.

4. The power failure managing device according to claim 1, wherein said information from said backup power source comprises the charge of said backup power source, the connection of said backup power source with said system, or both.

5. A power failure managing device in a card reader, comprising:
a backup power source;
a CPU having a processing unit that detects a power failure and actuates said backup power source upon detecting said power failure; and
a rewritable memory that records the status of said card reader at the moment of said power failure;
wherein if said CPU determines that said backup power source is not properly functioning at the moment of said power failure, information from said backup power source is recorded in said memory.

6. A method for managing a power failure comprising using the power failure managing device of claim 1.

7. The method for managing a power failure according to claim 6 further comprising the steps of:
(a) executing a process monitoring task to detect a power failure;
(b) determining whether said backup power source is properly functioning; and
(c) depending upon whether said backup power source is properly functioning, either actuating said backup power source to perform normal power failure management or recording information from said backup power source in said memory;
wherein said information is used to recover the process said system was performing before said power failure.
